(19) United States
(12) Patent Application Publication
(10) Pub. No.: US 2026/0179530 A1
(43) Pub. Date: Jun. 25, 2026

(54) PIXEL DRIVING CIRCUIT, DISPLAY APPARATUS, AND DISPLAY METHOD

(71) Applicant: BOE Technology Group Co., Ltd., Beijing (CN)

(72) Inventors: Can Wang, Beijing (CN); Can Zhang, Beijing (CN); Ning Cong, Beijing (CN); Jinfei Niu, Beijing (CN); Jingjing Zhang, Beijing (CN); Minghua Xuan, Beijing (CN); Xiaochuan Chen, Beijing (CN)

(73) Assignee: BOE Technology Group Co., Ltd., Beijing (CN)

(21) Appl. No.: 18/838,057

(22) PCT Filed: Mar. 28, 2023
(86) PCT No.: PCT/CN2023/084368

§ 371 Date: Aug. 13, 2024

(51) Int. Cl. G09G 3/32; G09G 3/20; G09G 3/3233

(52) U.S. Cl. CPC G09G 3/32; G09G 3/2074; G09G 3/3233; G09G 2300/0426; G09G 2300/0814; G09G 2300/0852; G09G 2300/0861; G09G 2310/08; G09G 2320/0233

(57) ABSTRACT

A pixel driving circuit is provided. The pixel driving circuit includes a first circuit and a second circuit. The first circuit is configured to provide a driving current to a light emitting element under control of the second circuit. The second circuit is configured to receive a digital select signal from a digital select signal line, a first digital data signal from a first digital data signal line, and a second digital data signal from a second digital data signal line; and control a frequency and duration by which the light emitting element receives the driving current during a frame of image, thereby controlling the grayscale of a subpixel having the light emitting element.

### TECHNICAL FIELD

The present invention relates to display technology, more particularly, to a pixel driving circuit, a display apparatus, and a display method.

### BACKGROUND

Augmented reality display apparatus has been developed recently, in which optical waveguide technology is often used to achieve a miniaturized structure. A higher display brightness is typically required in order to accommodate the use of the optical waveguide, due to the issue of relatively large light loss in the optical waveguide. Organic light emitting diodes have many advantages, however, have relatively low brightness. Inorganic light emitting diode display panels such as micro light emitting diode display panels or mini light emitting diode display panels, on the other hand, have relatively high light emitting intensity, and are particularly suitable for augmented reality display. Augmented reality display apparatus typically requires a pixel-per-inch of 5000 or higher, which means a pixel pitch of 5 microns or less.

### SUMMARY

In one aspect, the present disclosure provides a pixel driving circuit, comprising a first circuit and a second circuit; wherein the first circuit is configured to provide a driving current to a light emitting element under control of the second circuit; the second circuit is configured to receive a digital select signal from a digital select signal line, a first digital data signal from a first digital data signal line, and a second digital data signal from a second digital data signal line; and control a frequency and duration by which the light emitting element receives the driving current during a frame of image, thereby controlling the grayscale of a subpixel having the light emitting element.

Optionally, the second circuit comprises a latch, a first transistor, and a second transistor; wherein gate electrodes of the first transistor and the second transistor are coupled to the digital select signal line, and configured to receive the digital select signal from the digital select signal line; a first electrode of the first transistor is coupled to the first digital data signal line, and configured to receive the first digital data signal from the first digital data signal line; a second electrode of the first transistor is coupled to the latch; a first electrode of the second transistor is coupled to the second digital data signal line, and configured to receive the second digital data signal from the second digital data signal line; and a second electrode of the second transistor is coupled to the latch.

Optionally, the first circuit comprises a first subcircuit, a second subcircuit, and a third subcircuit; the third subcircuit is coupled to the second subcircuit, coupled to the light emitting element, and coupled to a first latch node in the second circuit; and a voltage level at the first latch node is configured to control the third subcircuit to allow or disallow the driving current from the second subcircuit to pass through the third subcircuit to the light emitting element.

Optionally, the second circuit comprises a latch, a first transistor, and a second transistor; wherein the latch comprises a third transistor, a fourth transistor, a fifth transistor, and a sixth transistor; gate electrodes of the fourth transistor and the sixth transistor are coupled to a first latch node in the second circuit, which is coupled to the second electrode of the first transistor; gate electrodes of the third transistor and the fifth transistor are coupled to the second latch node, which is coupled to the second electrode of the second transistor; second electrodes of the third transistor and the fifth transistor are coupled to the first latch node, which is coupled to the gate electrodes of the fourth transistor and the sixth transistor; second electrodes of the fourth transistor and the sixth transistor are coupled to a second latch node in the second circuit, which is coupled to the gate electrodes of the third transistor and the fifth transistor; first electrodes of the third transistor and the fourth transistor are coupled to a voltage supply signal line, and configured to receive a voltage supply signal from the voltage supply signal line; and first electrodes of the fifth transistor and the sixth transistor are coupled to a low voltage signal line, and configured to receive a low voltage signal from the low voltage signal line.

Optionally, the second circuit further comprises a seventh transistor and an eighth transistor; gate electrodes of the seventh transistor and the eighth transistor are coupled to the first latch node; second electrodes of the seventh transistor and the eighth transistor are coupled to a gate electrode of a light emitting control transistor in the first circuit; a first electrode of the seventh transistor is coupled to the voltage supply signal line; and a first electrode of the eighth transistor is coupled to the low voltage signal line.

Optionally, the first circuit comprises a storage capacitor, a first subcircuit, a second subcircuit, and a third subcircuit; the first subcircuit is coupled to a data line and a gate line, and configured to write a data signal to a first node; the second subcircuit is coupled to the first node, and configured to receive a voltage supply signal from a voltage supply signal line; and the second subcircuit is coupled to the first subcircuit and coupled to the third subcircuit.

Optionally, the first circuit comprises a storage capacitor, a first subcircuit, a second subcircuit, and a third subcircuit; the first subcircuit comprises at least a data write transistor; the second subcircuit comprises a driving transistor; the third subcircuit includes a light emitting control transistor; the gate electrode of the light emitting control transistor is coupled to a first latch node in the second circuit; a first electrode of the light emitting control transistor is coupled to a second electrode of the driving transistor; and a second electrode of the light emitting control transistor is coupled to an anode of the light emitting element.

Optionally, a gate electrode of the data write transistor is coupled to the gate line; a first electrode of the data write transistor is coupled to the data line; a second electrode of the data write transistor is coupled to a first node; a gate electrode of the driving transistor is coupled to the first node; a first electrode of the driving transistor is coupled to the voltage supply signal line; and a second electrode of the driving transistor is coupled to the first electrode of the light emitting control transistor.

Optionally, the first circuit further comprises a control transistor; wherein a gate electrode of the control transistor is coupled to the gate line, a first electrode of the control transistor is coupled to the voltage supply signal line, and a second electrode of the control transistor is coupled to a first electrode of the driving transistor.

Optionally, the first circuit further comprises an auxiliary capacitor; wherein a first electrode of the storage capacitor is coupled to the first node, a second electrode of the storage capacitor is coupled to a second electrode of the auxiliary capacitor, the first electrode of the driving transistor, and the second electrode of the control transistor; and a first electrode of the auxiliary capacitor is coupled to the voltage supply signal line, a second electrode of the auxiliary capacitor is coupled to the second electrode of the storage capacitor, the first electrode of the driving transistor, and the second electrode of the control transistor.

Optionally, the first circuit comprises a storage capacitor, a first subcircuit, a second subcircuit, and a third subcircuit; the first subcircuit comprises a first data write transistor and a second data write transistor; the first data write transistor is an n-type transistor and the second data write transistor is a p-type transistor; a gate electrode of the first data write transistor is coupled to a first gate line, and is configured to receive a first gate driving signal from the first gate line; a gate electrode of the second data write transistor is coupled to a second gate line, and is configured to receive a second gate driving signal from the second gate line; first electrodes of the first data write transistor and the second data write transistor are coupled to a data line; and second electrodes of the first data write transistor and the second data write transistor are coupled to a first node.

Optionally, the frequency and duration by which the light emitting element receives the driving current during the frame of image is correlated to frequency and duration of an effective voltage of a digital select signal provided to a digital select signal line during the frame of image.

In another aspect, the present disclosure provides a display apparatus, comprising a plurality of light emitting elements arranged in an array; wherein a respective light emitting element is in a subpixel; the subpixel is connected to the pixel driving circuit described herein; and the respective light emitting element is a mini light emitting diode or a micro light emitting diode.

Optionally, the pixel driving circuit is on a silicon-based base substrate.

In another aspect, the present disclosure provides a display method, comprising providing a pixel driving circuit comprising a first circuit and a second circuit; providing, by the first circuit, a driving current to a light emitting element under control of the second circuit; receiving, by the second circuit, a digital select signal from a digital select signal line, a first digital data signal from a first digital data signal line, and a second digital data signal from a second digital data signal line; and controlling, by the second circuit, a frequency and duration by which the light emitting element receives the driving current during a frame of image, thereby controlling the grayscale of a subpixel having the light emitting element.

Optionally, the second circuit comprises a latch, a first transistor, and a second transistor; wherein gate electrodes of the first transistor and the second transistor are coupled to the digital select signal line, and configured to receive the digital select signal from the digital select signal line; a first electrode of the first transistor is coupled to the first digital data signal line, and configured to receive the first digital data signal from the first digital data signal line; a second electrode of the first transistor is coupled to the latch; a first electrode of the second transistor is coupled to the second digital data signal line, and configured to receive the second digital data signal from the second digital data signal line; and a second electrode of the second transistor is coupled to the latch; wherein the display method further comprises turning on the first transistor by a gate-on voltage provided by the digital select signal line, allowing the first digital data signal from the first digital data signal line to pass to a first latch node; turning on the second transistor by the gate-on voltage provided by the digital select signal line, allowing the second digital data signal from the second digital data signal line to pass to the second latch node; and latching the first digital data signal and the second digital data signal by the latch.

Optionally, the display method further comprises setting a voltage level at the first latch node to be an effective voltage level; and allowing, by a third subcircuit in the first circuit, the driving current from a second subcircuit in the first circuit to pass through the third subcircuit to the light emitting element.

Optionally, the display method further comprises setting a voltage level at the first latch node to be an ineffective voltage level; and disallowing, by a third subcircuit in the first circuit, the driving current from a second subcircuit in the first circuit to pass through the third subcircuit to the light emitting element.

Optionally, the display method further comprises, in a first phase, providing a turning-on voltage signal through a gate line to a gate electrode of at least a data write transistor, turning on the data write transistor, allowing a data signal provided by the data line pass through the data write transistor, writing the data signal to a first node.

Optionally, the first subcircuit includes a first data write transistor and a second data write transistor; wherein the display method further comprises, in a first phase, providing a turning-on voltage signal through a first gate line to a gate electrode of the first data write transistor, turning on the first data write transistor; providing a turning-on voltage signal through a second gate line to a gate electrode of the second data write transistor, turning on the second data write transistor; and allowing a data signal provided by the data line pass through the first data write transistor and the second data write transistor, respectively, writing the data signal to a first node.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a pixel driving circuit in some embodiments according to the present disclosure.

FIG. 2 is a schematic diagram illustrating the structure of a pixel driving circuit in some embodiments according to the present disclosure.

FIG. 3A is a schematic diagram illustrating the structure of a pixel driving circuit in some embodiments according to the present disclosure.

FIG. 3B is a schematic diagram illustrating the structure of a pixel driving circuit in some embodiments according to the present disclosure.

FIG. 4 is a timing diagram illustrating the operation of a pixel driving circuit in some embodiments according to the present disclosure.

FIG. 5A is a schematic diagram illustrating the structure of a pixel driving circuit in some embodiments according to the present disclosure.

FIG. 5B is a schematic diagram illustrating the structure of a pixel driving circuit in some embodiments according to the present disclosure.

FIG. 6 is a timing diagram illustrating the operation of a pixel driving circuit in some embodiments according to the present disclosure.

FIG. 7 is a plan view of a display apparatus in some embodiments according to the present disclosure.

FIG. 8 is a flow chart illustrating a display method in some embodiments according to the present disclosure.

FIG. 9 is a flow chart illustrating a display method in some embodiments according to the present disclosure.

FIG. 10 is a flow chart illustrating a display method in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In certain display scenarios such as augmented reality display, a higher display stability is required. For example, display involved in wearable devices or outdoor sports has a higher requirement for withstanding external disturbance, but has a lower requirement for display grayscale. These display scenarios place a high demand on stable and reliable pixel driving.

Accordingly, the present disclosure provides, inter alia, a pixel driving circuit, a display apparatus, and a display method that substantially obviate one or more of the problems due to limitations and disadvantages of the related art. In one aspect, the present disclosure provides a pixel driving circuit. In some embodiments, the pixel driving circuit includes a first circuit and a second circuit. Optionally, the first circuit is configured to provide a driving current to a light emitting element under control of the second circuit. Optionally, the second circuit is configured to receive a digital select signal from a digital select signal line, a first digital data signal from a first digital data signal line, and a second digital data signal from a second digital data signal line; and control a frequency and duration by which the light emitting element receives the driving current during a frame of image, thereby controlling the grayscale of a subpixel having the light emitting element.

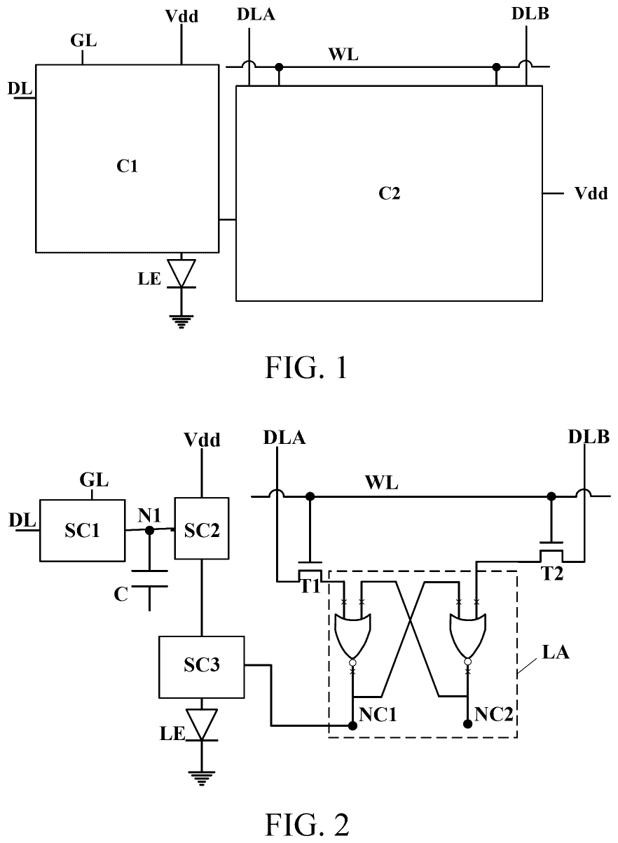

FIG. 1 is a schematic diagram illustrating the structure of a pixel driving circuit in some embodiments according to the present disclosure. Referring to FIG. 1, the pixel driving circuit in some embodiments includes a first circuit C1 configured to provide a driving current to a light emitting element LE, and a second circuit C2 configured to control a frequency and duration by which the light emitting element LE receives the driving current during a frame of image, thereby controlling the grayscale of a subpixel having the light emitting element LE.

Referring to FIG. 1, the first circuit C1 in some embodiments is configured to receive a gate driving signal from a gate line GL, a data signal from a data line DL, a voltage supply signal from a voltage supply signal line Vdd.

Referring to FIG. 1, the second circuit C2 in some embodiments is configured to receive a digital select signal from a digital select signal line WL, a first digital data signal from a first digital data signal line DLA, and a second digital data signal from a second digital data signal line DLB. Optionally, the second circuit C2 is further configured to receive the voltage supply signal from the voltage supply signal line Vdd.

In some embodiments, the first circuit C1 is coupled to the second circuit C2, and coupled to an anode of the light emitting element LE. Optionally, the first circuit C1 is configured to provide the driving current to the light emitting element LE under control of the second circuit C2. Optionally, the frequency and duration by which the light emitting element LE receives the driving current during the frame of image is correlated to frequency and duration of an effective voltage of the digital select signal provided to the digital select signal line WL during the frame of image.

FIG. 2 is a schematic diagram illustrating the structure of a pixel driving circuit in some embodiments according to the present disclosure. Referring to FIG. 2, the first circuit C1 in some embodiments includes a first subcircuit SC1 coupled to the data line DL and the gate line. The first subcircuit SC1 is configured to write a data signal to a first node N1.

In some embodiments, the first circuit C1 further includes a second subcircuit SC2 coupled to the first node N1, and configured to receive the voltage supply signal from the voltage supply signal line Vdd. The second subcircuit SC2 is configured to provide a driving current to the light emitting element LE. The second subcircuit SC2 is coupled to the first subcircuit SC1 and coupled to a third subcircuit SC3.

In some embodiments, the first circuit C1 further includes a storage capacitor C. A first electrode of the storage capacitor C is coupled to the first node N1.

In some embodiments, the first circuit C1 further includes a third subcircuit SC3 coupled to the second subcircuit SC2, coupled to the light emitting element LE, and coupled to the second circuit.

In some embodiments, the second circuit C2 includes a latch LA, a first transistor T1, and a second transistor T2. Optionally, the latch LA is a bistable latch. Gate electrodes of the first transistor T1 and the second transistor T2 are coupled to the digital select signal line WL, and configured to receive the digital select signal from the digital select signal line WL. A first electrode of the first transistor T1 is coupled to the first digital data signal line DLA, and configured to receive the first digital data signal from the first digital data signal line DLA. A second electrode of the first transistor T1 is coupled to the latch LA. A first electrode of the second transistor T2 is coupled to the second digital data signal line DLB, and configured to receive the second digital data signal from the second digital data signal line DLB. A second electrode of the second transistor T2 is coupled to the latch LA.

In some embodiments, a first latch node NC1 is coupled to the third subcircuit SC3. A voltage level at the first latch node NC1 is configured to control the third subcircuit SC3 to allow or disallow the driving current from the second subcircuit SC2 to pass through the third subcircuit SC3 to the light emitting element LE.

The present disclosure may be implemented in pixel driving circuit having transistors of various types, including a pixel driving circuit having p-type transistors, a pixel driving circuit having n-type transistors, and a pixel driving circuit having one or more p-type transistors and one or more n-type transistors. FIG. 2 illustrates an example in which the first transistor T1 and the second transistor T2 are n-type transistors. However, the present disclosure may be implemented in pixel driving circuit having the first transistor T1 and the second transistor T2 of p-type transistors.

In one example, a transistor is an n-type transistor. A gate-on voltage of the n-type transistor may be set to a high level, and a gate-off voltage of the n-type transistor may be set to a low level.

In another example, a transistor is a p-type transistor. A gate-on voltage of the p-type transistor may be set to a low level, and a gate-off voltage of the p-type transistor may be set to a high level.

In some embodiments, the first transistor T1 is turned on by a gate-on voltage provided by the digital select signal line WL, allowing the first digital data signal from the first digital data signal line DLA to pass to the first latch node NC1. The second transistor T2 is turned on by the gate-on voltage provided by the digital select signal line WL, allowing the second digital data signal from the second digital data signal line DLB to pass to the second latch node NC2. The first digital data signal and the second digital data signal are latched by the latch LA. When the voltage level at the first latch node NC1 is an effective voltage level (e.g., a high voltage level), the third subcircuit SC3 allows the driving current from the second subcircuit SC2 to pass through the third subcircuit SC3 to the light emitting element LE. When the voltage level at the first latch node NC1 is an ineffective voltage level (e.g., a low voltage level), the third subcircuit SC3 disallows the driving current from the second subcircuit SC2 to pass through the third subcircuit SC3 to the light emitting element LE.

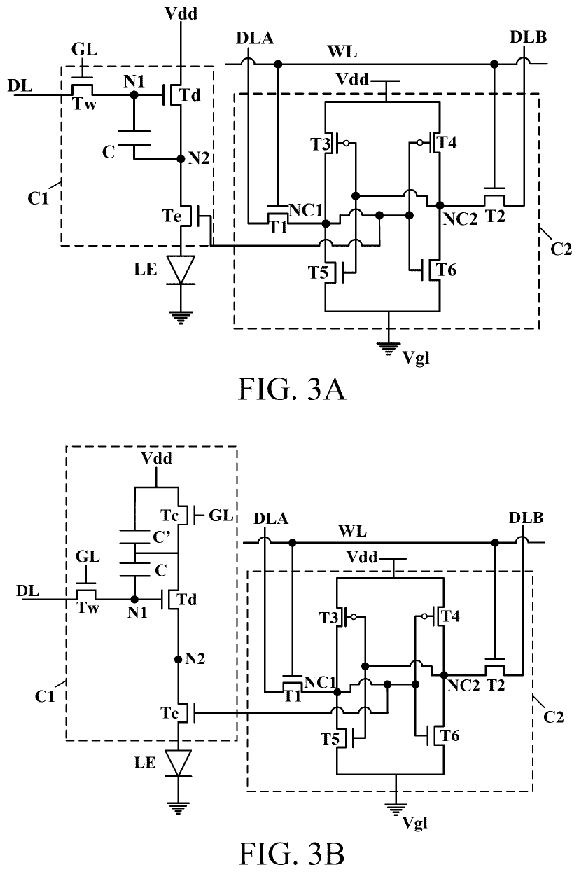

The present disclosure may be implemented in pixel driving circuit having first circuits of various types, including 3T1C, 2T1C, 4T1C, 4T2C, 5T2C, 6T1C, 7T1C, 7T2C, 8T1C, and 8T2C circuits. FIG. 3A is a schematic diagram illustrating the structure of a pixel driving circuit in some embodiments according to the present disclosure. Referring to FIG. 3A, the first circuit C1 is a 3T1C circuit. In some embodiments, referring to FIG. 2 and FIG. 3A, the first subcircuit SC1 includes a data write transistor Tw, the second subcircuit SC2 includes a driving transistor Td, the third subcircuit SC3 includes a light emitting control transistor Te.

A gate electrode of the data write transistor Tw is coupled to the gate line GL, a first electrode of the data write transistor Tw is coupled to the data line DL, a second electrode of the data write transistor Tw is coupled to the first node N1.

A gate electrode of the driving transistor Td is coupled to the first node N1. A first electrode of the driving transistor Td is coupled to the voltage supply signal line Vdd. A second electrode of the driving transistor Td is coupled to a second node N2.

A first electrode of the storage capacitor C is coupled to the first node N1. A second electrode of the storage capacitor C is coupled to the second node N2.

A gate electrode of the light emitting control transistor Te is coupled to the first latch node NC1. A first electrode of the light emitting control transistor Te is coupled to the second electrode of the driving transistor Td. A second electrode of the light emitting control transistor Te is coupled to the anode of the light emitting element LE.

The present disclosure may be implemented in pixel driving circuit having latches of various types. Referring to FIG. 3A, the latch in some embodiments includes a third transistor T3, a fourth transistor T4, a fifth transistor T5, and a sixth transistor T6. In the example depicted in FIG. 3A, the third transistor T3 and the fourth transistor T4 are p-type transistors; the first transistor T1, the second transistor T2, the first transistor T5, and the sixth transistor T6 are n-type transistors. The present disclosure may be implemented in pixel driving circuit having transistors of various types, including a pixel driving circuit having p-type transistors, a pixel driving circuit having n-type transistors, and a pixel driving circuit having one or more p-type transistors and one or more n-type transistors. For example, the present disclosure may be implemented with the third transistor T3 and the fourth transistor T4 be n-type transistors.

Gate electrodes of the fourth transistor T4 and the sixth transistor T6 are coupled to the first latch node NC1, which is coupled to the second electrode of the first transistor T1.

Gate electrodes of the third transistor T3 and the fifth transistor T5 are coupled to the second latch node NC2, which is coupled to the second electrode of the second transistor T2.

Second electrodes of the third transistor T3 and the fifth transistor T5 are coupled to the first latch node NC1, which is coupled to the gate electrodes of the fourth transistor T4 and the sixth transistor T6.

Second electrodes of the fourth transistor T4 and the sixth transistor T6 are coupled to the second latch node NC2, which is coupled to the gate electrodes of the third transistor T3 and the fifth transistor T5.

First electrodes of the third transistor T3 and the fourth transistor T4 are coupled to the voltage supply signal line Vdd, and configured to receive the voltage supply signal from the voltage supply signal line Vdd.

First electrodes of the fifth transistor T5 and the sixth transistor T6 are coupled to a low voltage signal line Vg1, and configured to receive a low voltage signal from the low voltage signal line Vg1.

FIG. 3B is a schematic diagram illustrating the structure of a pixel driving circuit in some embodiments according to the present disclosure. Referring to FIG. 3B, the first circuit C1 is a 4T2C circuit. In some embodiments, referring to FIG. 2 and FIG. 3B, the first subcircuit SC1 includes a data write transistor Tw, the second subcircuit SC2 includes a driving transistor Td and a control transistor Te, the third subcircuit SC3 includes a light emitting control transistor Te. The pixel driving circuit includes a storage capacitor C and an auxiliary capacitor C′.

A gate electrode of the data write transistor Tw is coupled to the gate line GL, a first electrode of the data write transistor Tw is coupled to the data line DL, a second electrode of the data write transistor Tw is coupled to the first node N1.

A gate electrode of the driving transistor Td is coupled to the first node N1. A first electrode of the driving transistor Td is coupled to a second electrode of the control transistor Tc, a second electrode of the storage capacitor C, and a second electrode of the auxiliary capacitor C′. A second electrode of the driving transistor Td is coupled to a second node N2.

A gate electrode of the control transistor Te is coupled to the gate line GL, a first electrode of the control transistor Te is coupled to the voltage supply signal line Vdd. A second electrode of the control transistor Te is coupled to the first electrode of the driving transistor Td.

A first electrode of the storage capacitor C is coupled to the first node N1. A second electrode of the storage capacitor C is coupled to a second electrode of the auxiliary capacitor C′, the first electrode of the driving transistor Td, and the second electrode of the control transistor Tc.

A first electrode of the auxiliary capacitor C′ is coupled to the voltage supply signal line Vdd. A second electrode of the auxiliary capacitor C′ is coupled to the second electrode of the storage capacitor C, the first electrode of the driving transistor Td, and the second electrode of the control transistor Tc.

A gate electrode of the light emitting control transistor Te is coupled to the first latch node NC1. A first electrode of the light emitting control transistor Te is coupled to the second electrode of the driving transistor Td. A second electrode of the light emitting control transistor Te is coupled to the anode of the light emitting element LE.

The inventors of the present disclosure discover that the auxiliary capacitor C′ and the control transistor To enable the first circuit C1 to output a more stable driving current. The presence of the storage capacitor and the auxiliary capacitor can effectively compensate the threshold voltage of the driving transistor Td, enhancing display uniformity.

The second circuit C2 depicted in FIG. 3B is substantially the same as the second circuit C2 depicted in FIG. 3A.

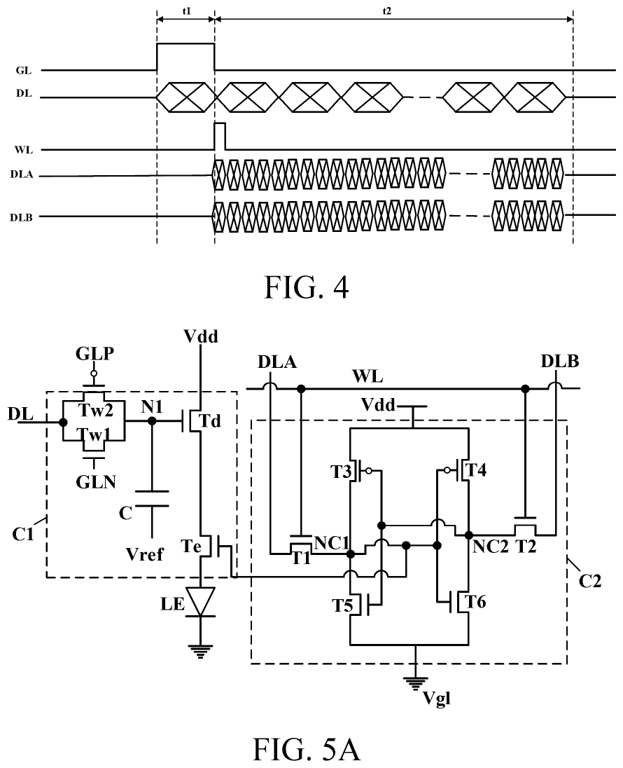

FIG. 4 is a timing diagram illustrating the operation of a pixel driving circuit in some embodiments according to the present disclosure. Referring to FIG. 3A, FIG. 3B, and FIG. 4, during one frame of image, the operation of the pixel driving circuit includes a first phase t1 and a second phase t2. In the first phase t1, a turning-on voltage signal is provided through the gate line GL to the gate electrode of the data write transistor Tw, turning on the data write transistor Tw. A data signal provided by the data line DL passes through the data write transistor Tw, writing the data signal to a first node N1, which is stored in the storage capacitor C.

In the second phase t2, an effective voltage of the digital select signal is provided to gate electrodes of the first transistor T1 and the second transistor T2 through the digital select signal line WL, turning on the first transistor T1 and the second transistor T2. A first digital data signal provided by the first digital data signal line DLA passes through the first transistor T1 to the first latch node NC1, and a second digital signal provided by the second digital data signal line DLB passes through the second transistor T2 to the second latch node NC2.

In some embodiments, when the first latch node NC1 is charged to a logic high voltage level (e.g., “1”), and the second latch node NC2 is charged to a logic low voltage level (e.g., “0”), the sixth transistor T6 is turned on by the logic high voltage level at the first latch node NC1, the low voltage signal from the low voltage signal line Vg1 passes through the sixth transistor T6 to the second latch node NC2, maintaining the second latch node NC2 at the logic low voltage level. Meanwhile, the third transistor T3 is turned on by the logic low voltage level at the second latch node NC2, the voltage supply signal from the voltage supply signal line Vdd passes through the third transistor T3 to the first latch node NC1, maintaining the first latch node NC1 at the logic high voltage level. When the first latch node NC1 is charged to the logic high voltage level, and the second latch node NC2 is charged to the logic low voltage level, the light emitting control transistor Te is turned on, allowing the driving current from the second electrode of the driving transistor to pass to the light emitting element LE.

In some embodiments, when the first latch node NC1 is charged to a logic low voltage level (e.g., “0”), and the second latch node NC2 is charged to a logic high voltage level (e.g., “1”), the fifth transistor T5 is turned on by the logic high voltage level at the second latch node NC2, the low voltage signal from the low voltage signal line Vg1 passes through the fifth transistor T5 to the first latch node NC1, maintaining the first latch node NC1 at the logic low voltage level. Meanwhile, the fourth transistor T4 is turned on by the logic low voltage level at the first latch node NC1, the voltage supply signal from the voltage supply signal line Vdd passes through the fourth transistor T4 to the second latch node NC2, maintaining the second latch node NC2 at the logic high voltage level. When the first latch node NC1 is charged to the logic low voltage level, and the second latch node NC2 is charged to the logic high voltage level, the light emitting control transistor Te is turned off, disallowing the driving current from the second electrode of the driving transistor to pass to the light emitting element LE.

Accordingly, frequency and duration of an effective voltage of the digital select signal provided to the digital select signal line WL during the frame of image determines the frequency and duration by which the light emitting element LE receives the driving current during the frame of image, thereby controlling the grayscale of a subpixel having the light emitting element LE. In one example, a higher frequency of the effective voltage of the digital select signal provided to the digital select signal line WL during the frame of image results in a higher grayscale of the subpixel having the light emitting element LE. In another example, a longer duration of each individual effective voltage of the digital select signal provided to the digital select signal line WL during the frame of image results in a higher grayscale of the subpixel having the light emitting element LE.

The inventors of the present disclosure discover that, surprisingly and unexpectedly, a more stable and reliable display can be achieved using the present pixel driving circuit. In the present driving circuit, the first circuit is configured to provide the driving current, and the second circuit is configured to control the duration by which the light emitting element receives the driving current during the frame of image. The second circuit has a higher stability, particularly with respect to controlling the duration. The inventors of the present disclosure discover that the present pixel driving circuit is particularly conducive for a display panel having a silicon-based back plate. In one example, the present pixel driving circuit is fabricated on a silicon-based base substrate. In another example, the present pixel driving circuit is suitable for implementation in a display panel having a lower grayscale requirement. Due to the storage function of the second circuit, image display in such display panels is more stable and reliable, and is simpler to implement.

In some embodiments, the silicon-based back plate or the silicon-based base substrate includes silicon element, e.g., polycrystalline silicon or monocrystalline silicon. As compared to a glass-based back plate or a glass base substrate, transistors fabricated on the silicon-based back plate or the silicon-based base substrate have a smaller size, e.g., in a range of tens to hundreds of nanometers, whereas a size of a transistor fabricated on a glass-based back plate or a glass base substrate is in a range of a few micrometers to tens of micrometers. The conduction time of silicon-based transistors is in a range of tens of picoseconds, whereas the conduction time of glass-based transistors is between tens and hundreds of nanoseconds.

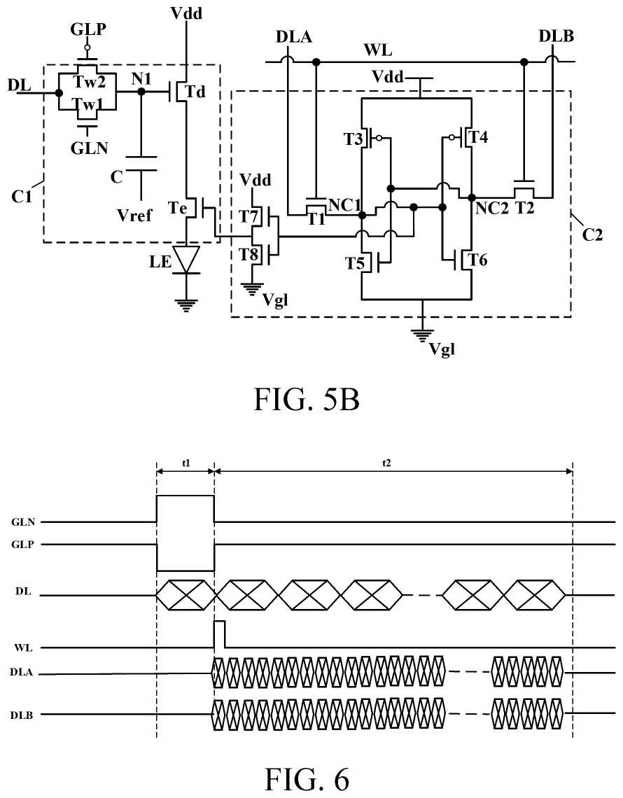

FIG. 5A is a schematic diagram illustrating the structure of a pixel driving circuit in some embodiments according to the present disclosure. Referring to FIG. 5A, the first subcircuit includes a first data write transistor Tw1 and a second data write transistor Tw2.

Optionally, the first data write transistor Tw1 is an n-type transistor and the second data write transistor Tw2 is a p-type transistor. A first electrode of the storage capacitor C is coupled to the first node N1. A second electrode of the storage capacitor C is coupled to a reference voltage signal line Vref, and is configured to receive a reference voltage signal from the reference voltage signal line Vref.

A gate electrode of the first data write transistor Tw1 is coupled to a first gate line GLN, and is configured to receive a first gate driving signal from the first gate line GLN. A gate electrode of the second data write transistor Tw2 is coupled to a second gate line GLP, and is configured to receive a second gate driving signal from the second gate line GLP. An effective voltage level of the first gate driving signal is a high voltage level, whereas an effective voltage level of the second gate driving signal is a low voltage level. Turning-on voltages for the first data write transistor Tw1 and the second data write transistor Tw2 differ from each other. Particularly for micro light emitting diodes, due to the limitations of the fabrication process and techniques, a data range applied by the pixel driving circuit to the light emitting element is limited to certain extent, resulting in a limited range of brightness adjustment of the subpixel. By having the first data write transistor Tw1 and the second data write transistor Tw2 with differing turning-on voltages, the data range applied by the pixel driving circuit to the light emitting element can be increased.

FIG. 5B is a schematic diagram illustrating the structure of a pixel driving circuit in some embodiments according to the present disclosure. The first circuit C1 depicted in FIG. 5B is substantially the same as the first circuit C1 depicted in FIG. 5A. Referring to FIG. 5B, the second circuit C2 in some embodiments further includes a seventh transistor T7 and an eighth transistor T8.

Gate electrodes of the seventh transistor T7 and the eighth transistor T8 are coupled to the first latch node NC1.

Second electrodes of the seventh transistor T7 and the eighth transistor T8 are coupled to the gate electrode of the light emitting control transistor Te.

A first electrode of the seventh transistor T7 is coupled to the voltage supply signal line Vdd.

A first electrode of the eighth transistor T8 is coupled to the low voltage signal line Vg1.

A gate electrode of the light emitting control transistor Te is coupled to the second electrodes of the seventh transistor T7 and the eighth transistor T8. A first electrode of the light emitting control transistor Te is coupled to the second electrode of the driving transistor Td. A second electrode of the light emitting control transistor Te is coupled to the anode of the light emitting element LE.

In some embodiments, the first latch node NC1 is coupled to the gate electrodes of the seventh transistor T7 and the eighth transistor T8. A voltage level at the first latch node NC1 is configured to control on or off of the seventh transistor T7 and the eighth transistor T8. The voltage level at the first latch node NC1 is configured to control the seventh transistor T7 to allow or disallow a voltage supply signal from the voltage supply signal line Vdd to pass through the seventh transistor T7 to the gate electrode of the light emitting control transistor Te. In turn, the voltage level at the first latch node NC1 is configured to control the third subcircuit SC3 to allow or disallow the driving current from the second subcircuit SC2 to pass through the third subcircuit SC3 to the light emitting element LE.

In some embodiments, the first transistor T1 is turned on by a gate-on voltage provided by the digital select signal line WL, allowing the first digital data signal from the first digital data signal line DLA to pass to the first latch node NC1. The second transistor T2 is turned on by the gate-on voltage provided by the digital select signal line WL, allowing the second digital data signal from the second digital data signal line DLB to pass to the second latch node NC2. The first digital data signal and the second digital data signal are latched by the latch LA. When the voltage level at the first latch node NC1 is an effective voltage level (e.g., a high voltage level), the third subcircuit SC3 (including the light emitting control transistor Te) allows the driving current from the second subcircuit SC2 to pass through the third subcircuit SC3 to the light emitting element LE. When the voltage level at the first latch node NC1 is an ineffective voltage level (e.g., a low voltage level), the third subcircuit SC3 (including the light emitting control transistor Te) disallows the driving current from the second subcircuit SC2 to pass through the third subcircuit SC3 to the light emitting element LE The inventors of the present disclosure discover that, by having the seventh transistor T7 and the eighth transistor T8, the voltage signal at the first latch node NC1 can be rectified by the seventh transistor T7 and the eighth transistor T8, and a more stable control signal can be output to the gate electrode of the light emitting control transistor Te.

FIG. 6 is a timing diagram illustrating the operation of a pixel driving circuit in some embodiments according to the present disclosure. Referring to FIG. 5A, FIG. 5B, and FIG. 6, during one frame of image, the operation of the pixel driving circuit includes a first phase t1 and a second phase t2. In the first phase t1, a turning-on voltage signal (a high voltage signal) is provided through the first gate line GLN to the gate electrode of the first data write transistor Tw1, turning on the first data write transistor Tw1. A turning-on voltage signal (a low voltage signal) is provided through the second gate line GLP to the gate electrode of the second data write transistor Tw2, turning on the second data write transistor Tw2. A data signal provided by the data line DL passes through the first data write transistor Tw1 and the second data write transistor Tw2, respectively, writing the data signal to a first node N1, which is stored in the storage capacitor C.

In the second phase t2, an effective voltage of the digital select signal is provided to gate electrodes of the first transistor T1 and the second transistor T2 through the digital select signal line WL, turning on the first transistor T1 and the second transistor T2. A first digital data signal provided by the first digital data signal line DLA passes through the first transistor T1 to the first latch node NC1, and a second digital signal provided by the second digital data signal line DLB passes through the second transistor T2 to the second latch node NC2.

In some embodiments, when the first latch node NC1 is charged to a logic high voltage level (e.g., “1”), and the second latch node NC2 is charged to a logic low voltage level (e.g., “0”), the sixth transistor T6 is turned on by the logic high voltage level at the first latch node NC1, the low voltage signal from the low voltage signal line Vg1 passes through the sixth transistor T6 to the second latch node NC2, maintaining the second latch node NC2 at the logic low voltage level. Meanwhile, the third transistor T3 is turned on by the logic low voltage level at the second latch node NC2, the voltage supply signal from the voltage supply signal line Vdd passes through the third transistor T3 to the first latch node NC1, maintaining the first latch node NC1 at the logic high voltage level. When the first latch node NC1 is charged to the logic high voltage level, and the second latch node NC2 is charged to the logic low voltage level, the light emitting control transistor Te is turned on, allowing the driving current from the second electrode of the driving transistor to pass to the light emitting element LE.

In some embodiments, when the first latch node NC1 is charged to a logic low voltage level (e.g., “0”), and the second latch node NC2 is charged to a logic high voltage level (e.g., “1”), the fifth transistor T5 is turned on by the logic high voltage level at the second latch node NC2, the low voltage signal from the low voltage signal line Vg1 passes through the fifth transistor T5 to the first latch node NC1, maintaining the first latch node NC1 at the logic low voltage level. Meanwhile, the fourth transistor T4 is turned on by the logic low voltage level at the first latch node NC1, the voltage supply signal from the voltage supply signal line Vdd passes through the fourth transistor T4 to the second latch node NC2, maintaining the second latch node NC2 at the logic high voltage level. When the first latch node NC1 is charged to the logic low voltage level, and the second latch node NC2 is charged to the logic high voltage level, the light emitting control transistor Te is turned off, disallowing the driving current from the second electrode of the driving transistor to pass to the light emitting element LE.

Accordingly, frequency and duration of an effective voltage of the digital select signal provided to the digital select signal line WL during the frame of image determines the frequency and duration by which the light emitting element LE receives the driving current during the frame of image, thereby controlling the grayscale of a subpixel having the light emitting element LE. In one example, a higher frequency of the effective voltage of the digital select signal provided to the digital select signal line WL during the frame of image results in a higher grayscale of the subpixel having the light emitting element LE. In another example, a longer duration of each individual effective voltage of the digital select signal provided to the digital select signal line WL during the frame of image results in a higher grayscale of the subpixel having the light emitting element LE.

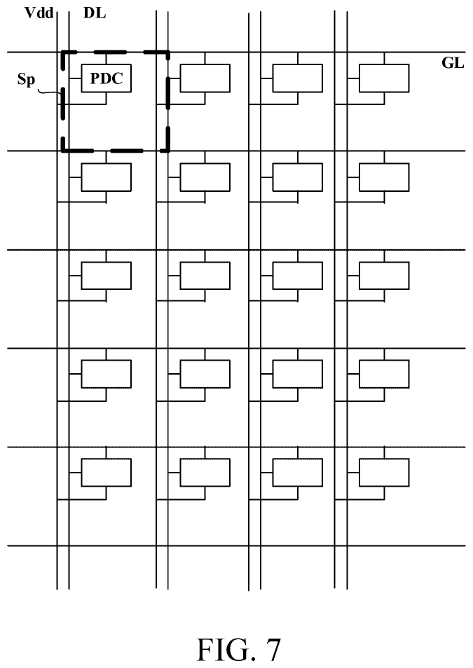

In another aspect, the present disclosure provides a display apparatus having the pixel driving circuit described herein, and a light emitting element connected to the pixel driving circuit. FIG. 7 is a plan view of a display apparatus in some embodiments according to the present disclosure. Referring to FIG. 7, the display apparatus in some embodiments includes an array of subpixels Sp. Each subpixel includes an electronic component, e.g., a light emitting element. In one example, the light emitting element is driven by a pixel driving circuit PDC.

The array substrate includes a plurality of gate lines, a plurality of data lines, and a plurality of voltage supply lines. Light emission in a respective subpixel is driven by the pixel driving circuit PDC. In one example, a high voltage signal is input, through a voltage supply line Vdd, to the pixel driving circuit PDC connected to an anode of the light emitting element; a low voltage signal is input to a cathode of the light emitting element. A voltage difference between the high voltage signal (e.g., the VDD signal) and the low voltage signal (e.g., the VSS signal) is a driving voltage AV that drives light emission in the light emitting element. In one example, the array substrate is fabricated on a silicon-based base substrate.

Various appropriate light emitting elements may be used in the present array substrate. Examples of appropriate light emitting elements include organic light emitting diodes, quantum dots light emitting diodes, and micro light emitting diodes. Optionally, the light emitting element is a micro light emitting diode. In another example, the display apparatus is an augmented reality display apparatus. In another example, the display apparatus is wearable display apparatus.

Examples of appropriate display apparatuses include, but are not limited to, an electronic paper, a mobile phone, a tablet computer, a television, a monitor, a notebook computer, a digital album, a GPS, etc. Optionally, the display apparatus is an organic light emitting diode display apparatus. Optionally, the display apparatus is a micro light emitting diode display apparatus. Optionally, the display apparatus is a mini light emitting diode display apparatus.

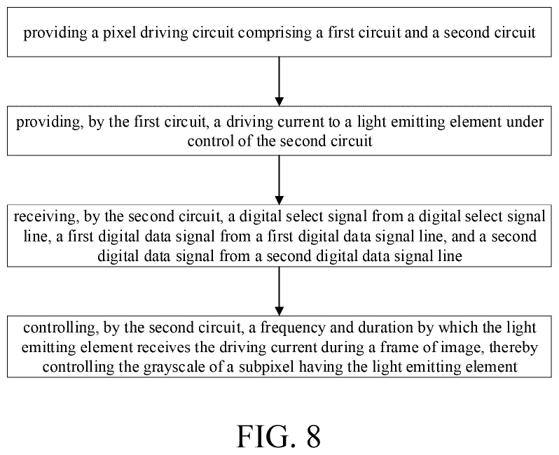

In another aspect, the present disclosure provides a display method. FIG. 8 is a flow chart illustrating a display method in some embodiments according to the present disclosure.

Referring to FIG. 8, the display method in some embodiments includes providing a pixel driving circuit comprising a first circuit and a second circuit; providing, by the first circuit, a driving current to a light emitting element under control of the second circuit; receiving, by the second circuit, a digital select signal from a digital select signal line, a first digital data signal from a first digital data signal line, and a second digital data signal from a second digital data signal line; and controlling, by the second circuit, a frequency and duration by which the light emitting element receives the driving current during a frame of image, thereby controlling the grayscale of a subpixel having the light emitting element.

In some embodiments, the second circuit comprises a latch, a first transistor, and a second transistor. Optionally, gate electrodes of the first transistor and the second transistor are coupled to the digital select signal line, and configured to receive the digital select signal from the digital select signal line. Optionally, a first electrode of the first transistor is coupled to the first digital data signal line, and configured to receive the first digital data signal from the first digital data signal line. Optionally, a second electrode of the first transistor is coupled to the latch. Optionally, a first electrode of the second transistor is coupled to the second digital data signal line, and configured to receive the second digital data signal from the second digital data signal line. Optionally, a second electrode of the second transistor is coupled to the latch.

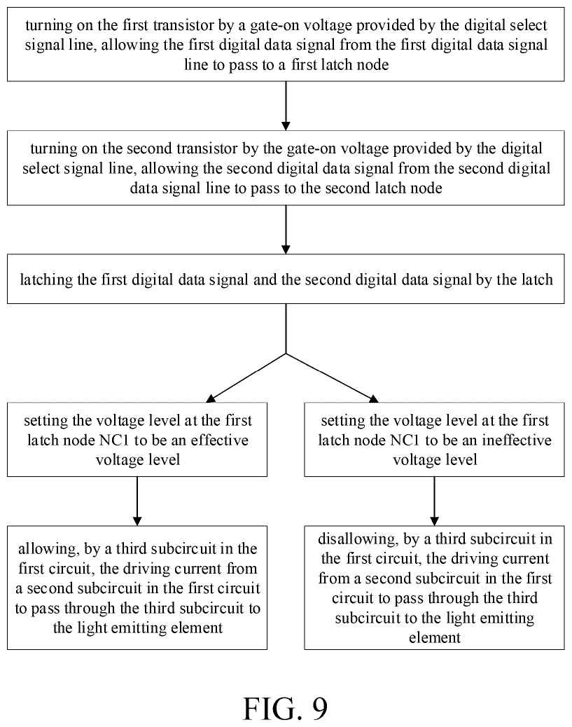

FIG. 9 is a flow chart illustrating a display method in some embodiments according to the present disclosure. Referring to FIG. 9, the display method in some embodiments further includes turning on the first transistor by a gate-on voltage provided by the digital select signal line, allowing the first digital data signal from the first digital data signal line to pass to a first latch node; turning on the second transistor by the gate-on voltage provided by the digital select signal line, allowing the second digital data signal from the second digital data signal line to pass to the second latch node; and latching the first digital data signal and the second digital data signal by the latch. Optionally, the display method further includes setting a voltage level at the first latch node to be an effective voltage level (e.g., a high voltage level), allowing, by a third subcircuit in the first circuit, the driving current from a second subcircuit in the first circuit to pass through the third subcircuit to the light emitting element. Optionally, the display method further includes setting a voltage level at the first latch node to be an ineffective voltage level (e.g., a low voltage level), disallowing, by a third subcircuit in the first circuit, the driving current from a second subcircuit in the first circuit to pass through the third subcircuit to the light emitting element.

In some embodiments, the display method includes, in a first phase, providing a turning-on voltage signal through a gate line to a gate electrode of at least a data write transistor, turning on the data write transistor and allowing a data signal provided by the data line pass through the data write transistor, writing the data signal to a first node.

In some embodiments, the first subcircuit includes a first data write transistor and a second data write transistor. Optionally, the first data write transistor is an n-type transistor and the second data write transistor is a p-type transistor. In some embodiments, the display method includes, in a first phase, providing a turning-on voltage signal (a high voltage signal) through a first gate line to a gate electrode of the first data write transistor, turning on the first data write transistor; providing a turning-on voltage signal (a low voltage signal) through a second gate line to a gate electrode of the second data write transistor, turning on the second data write transistor; allowing a data signal provided by the data line pass through the first data write transistor and the second data write transistor, respectively, writing the data signal to a first node.

In some embodiments, the display method further includes, in a second phase, providing an effective voltage of a digital select signal to gate electrodes of the first transistor and the second transistor through a digital select signal line, turning on the first transistor and the second transistor, allowing a first digital data signal provided by the first digital data signal line pass through the first transistor to the first latch node, and a second digital signal provided by the second digital data signal line pass through the second transistor to the second latch node.

In some embodiments, the second circuit includes a latch, a first transistor, and a second transistor. Optionally, the latch includes a third transistor, a fourth transistor, a fifth transistor, and a sixth transistor. Optionally, gate electrodes of the fourth transistor and the sixth transistor are coupled to a first latch node in the second circuit, which is coupled to the second electrode of the first transistor. Optionally, gate electrodes of the third transistor and the fifth transistor are coupled to the second latch node, which is coupled to the second electrode of the second transistor. Optionally, second electrodes of the third transistor and the fifth transistor are coupled to the first latch node, which is coupled to the gate electrodes of the fourth transistor and the sixth transistor. Optionally, second electrodes of the fourth transistor and the sixth transistor are coupled to a second latch node in the second circuit, which is coupled to the gate electrodes of the third transistor and the fifth transistor. Optionally, first electrodes of the third transistor and the fourth transistor are coupled to a voltage supply signal line, and configured to receive a voltage supply signal from the voltage supply signal line.

Optionally, first electrodes of the fifth transistor and the sixth transistor are coupled to a low voltage signal line, and configured to receive a low voltage signal from the low voltage signal line.

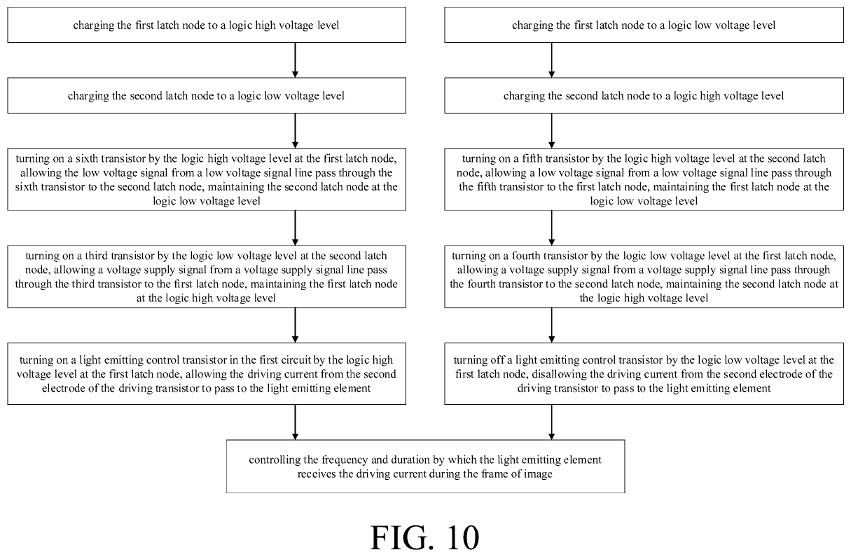

FIG. 10 is a flow chart illustrating a display method in some embodiments according to the present disclosure. Referring to FIG. 10, in some embodiments, controlling the frequency and duration by which the light emitting element receives the driving current during the frame of image includes charging the first latch node to a logic high voltage level (e.g., “1”); charging the second latch node to a logic low voltage level (e.g., “0”); turning on a sixth transistor by the logic high voltage level at the first latch node, allowing the low voltage signal from a low voltage signal line pass through the sixth transistor to the second latch node, maintaining the second latch node at the logic low voltage level; turning on a third transistor by the logic low voltage level at the second latch node, allowing a voltage supply signal from a voltage supply signal line pass through the third transistor to the first latch node, maintaining the first latch node at the logic high voltage level; and turning on a light emitting control transistor in the first circuit by the logic high voltage level at the first latch node, allowing the driving current from the second electrode of the driving transistor to pass to the light emitting element.

In some embodiments, controlling the frequency and duration by which the light emitting element receives the driving current during the frame of image further includes charging the first latch node to a logic low voltage level (e.g., “0”); charging the second latch node to a logic high voltage level (e.g., “1”); turning on a fifth transistor by the logic high voltage level at the second latch node, allowing a low voltage signal from a low voltage signal line pass through the fifth transistor to the first latch node, maintaining the first latch node at the logic low voltage level; turning on a fourth transistor by the logic low voltage level at the first latch node, allowing a voltage supply signal from a voltage supply signal line pass through the fourth transistor to the second latch node, maintaining the second latch node at the logic high voltage level; and turning off a light emitting control transistor by the logic low voltage level at the first latch node, disallowing the driving current from the second electrode of the driving transistor to pass to the light emitting element.

In another aspect, the present disclosure provides a method of fabricating a pixel driving circuit. The method in some embodiments includes forming a first circuit and forming a second circuit. Optionally, the first circuit is configured to provide a driving current to a light emitting element under control of the second circuit. Optionally, the second circuit is configured to receive a digital select signal from a digital select signal line, a first digital data signal from a first digital data signal line, and a second digital data signal from a second digital data signal line; and control a frequency and duration by which the light emitting element receives the driving current during a frame of image, thereby controlling the grayscale of a subpixel having the light emitting element.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A pixel driving circuit, comprising a first circuit and a second circuit;
wherein the first circuit is configured to provide a driving current to a light emitting element under control of the second circuit;
the second circuit is configured to:
receive a digital select signal from a digital select signal line, a first digital data signal from a first digital data signal line, and a second digital data signal from a second digital data signal line; and
control a frequency and duration by which the light emitting element receives the driving current during a frame of image, thereby controlling the grayscale of a subpixel having the light emitting element.

2. The pixel driving circuit of claim 1, wherein the second circuit comprises a latch, a first transistor, and a second transistor;
wherein gate electrodes of the first transistor and the second transistor are coupled to the digital select signal line, and configured to receive the digital select signal from the digital select signal line;
a first electrode of the first transistor is coupled to the first digital data signal line, and configured to receive the first digital data signal from the first digital data signal line;
a second electrode of the first transistor is coupled to the latch;
a first electrode of the second transistor is coupled to the second digital data signal line, and configured to receive the second digital data signal from the second digital data signal line; and
a second electrode of the second transistor is coupled to the latch.

3. The pixel driving circuit of claim 1, wherein the first circuit comprises a first subcircuit, a second subcircuit, and a third subcircuit;
the third subcircuit is coupled to the second subcircuit, coupled to the light emitting element, and coupled to a first latch node in the second circuit; and
a voltage level at the first latch node is configured to control the third subcircuit to allow or disallow the driving current from the second subcircuit to pass through the third subcircuit to the light emitting element.

4. The pixel driving circuit of claim 1, wherein the second circuit comprises a latch, a first transistor, and a second transistor;
wherein the latch comprises a third transistor, a fourth transistor, a fifth transistor, and a sixth transistor;
gate electrodes of the fourth transistor and the sixth transistor are coupled to a first latch node in the second circuit, which is coupled to the second electrode of the first transistor;
gate electrodes of the third transistor and the fifth transistor are coupled to the second latch node, which is coupled to the second electrode of the second transistor;
second electrodes of the third transistor and the fifth transistor are coupled to the first latch node, which is coupled to the gate electrodes of the fourth transistor and the sixth transistor;
second electrodes of the fourth transistor and the sixth transistor are coupled to a second latch node in the second circuit, which is coupled to the gate electrodes of the third transistor and the fifth transistor;
first electrodes of the third transistor and the fourth transistor are coupled to a voltage supply signal line, and configured to receive a voltage supply signal from the voltage supply signal line; and
first electrodes of the fifth transistor and the sixth transistor are coupled to a low voltage signal line, and configured to receive a low voltage signal from the low voltage signal line.

5. The pixel driving circuit of claim 4, wherein the second circuit further comprises a seventh transistor and an eighth transistor;
gate electrodes of the seventh transistor and the eighth transistor are coupled to the first latch node;
second electrodes of the seventh transistor and the eighth transistor are coupled to a gate electrode of a light emitting control transistor in the first circuit;
a first electrode of the seventh transistor is coupled to the voltage supply signal line; and
a first electrode of the eighth transistor is coupled to the low voltage signal line.

6. The pixel driving circuit of claim 1, wherein
the first circuit comprises a storage capacitor, a first subcircuit, a second subcircuit, and a third subcircuit;
the first subcircuit is coupled to a data line and a gate line, and configured to write a data signal to a first node;
the second subcircuit is coupled to the first node, and configured to receive a voltage supply signal from a voltage supply signal line; and
the second subcircuit is coupled to the first subcircuit and coupled to the third subcircuit.

7. The pixel driving circuit of claim 1, wherein the first circuit comprises a storage capacitor, a first subcircuit, a second subcircuit, and a third subcircuit;
the first subcircuit comprises at least a data write transistor;
the second subcircuit comprises a driving transistor;
the third subcircuit includes a light emitting control transistor;
the gate electrode of the light emitting control transistor is coupled to a first latch node in the second circuit;
a first electrode of the light emitting control transistor is coupled to a second electrode of the driving transistor; and
a second electrode of the light emitting control transistor is coupled to an anode of the light emitting element.

8. The pixel driving circuit of claim 7, wherein a gate electrode of the data write transistor is coupled to the gate line;
a first electrode of the data write transistor is coupled to the data line;
a second electrode of the data write transistor is coupled to a first node;
a gate electrode of the driving transistor is coupled to the first node;
a first electrode of the driving transistor is coupled to the voltage supply signal line; and
a second electrode of the driving transistor is coupled to the first electrode of the light emitting control transistor.

9. The pixel driving circuit of claim 7, wherein the first circuit further comprises a control transistor;
wherein a gate electrode of the control transistor is coupled to the gate line, a first electrode of the control transistor is coupled to the voltage supply signal line, and a second electrode of the control transistor is coupled to a first electrode of the driving transistor.

10. The pixel driving circuit of claim 9, wherein the first circuit further comprises an auxiliary capacitor;
wherein a first electrode of the storage capacitor is coupled to the first node, a second electrode of the storage capacitor is coupled to a second electrode of the auxiliary capacitor, the first electrode of the driving transistor, and the second electrode of the control transistor; and
a first electrode of the auxiliary capacitor is coupled to the voltage supply signal line, a second electrode of the auxiliary capacitor is coupled to the second electrode of the storage capacitor, the first electrode of the driving transistor, and the second electrode of the control transistor.

11. The pixel driving circuit of claim 1, wherein the first circuit comprises a storage capacitor, a first subcircuit, a second subcircuit, and a third subcircuit;
the first subcircuit comprises a first data write transistor and a second data write transistor;
the first data write transistor is an n-type transistor and the second data write transistor is a p-type transistor;
a gate electrode of the first data write transistor is coupled to a first gate line, and is configured to receive a first gate driving signal from the first gate line;
a gate electrode of the second data write transistor is coupled to a second gate line, and is configured to receive a second gate driving signal from the second gate line;
first electrodes of the first data write transistor and the second data write transistor are coupled to a data line; and
second electrodes of the first data write transistor and the second data write transistor are coupled to a first node.

12. The pixel driving circuit of claim 1, wherein the frequency and duration by which the light emitting element receives the driving current during the frame of image is correlated to frequency and duration of an effective voltage of a digital select signal provided to a digital select signal line during the frame of image.

13. A display apparatus, comprising a plurality of light emitting elements arranged in an array;
wherein a respective light emitting element is in a subpixel;
the subpixel is connected to the pixel driving circuit of claim 1; and
the respective light emitting element is a mini light emitting diode or a micro light emitting diode.

14. The display apparatus of claim 10, wherein the pixel driving circuit is on a silicon-based base substrate.

15. A display method, comprising:
providing a pixel driving circuit comprising a first circuit and a second circuit;
providing, by the first circuit, a driving current to a light emitting element under control of the second circuit;
receiving, by the second circuit, a digital select signal from a digital select signal line, a first digital data signal from a first digital data signal line, and a second digital data signal from a second digital data signal line; and
controlling, by the second circuit, a frequency and duration by which the light emitting element receives the driving current during a frame of image, thereby controlling the grayscale of a subpixel having the light emitting element.

16. The display method of claim 12, wherein the second circuit comprises a latch, a first transistor, and a second transistor;
wherein gate electrodes of the first transistor and the second transistor are coupled to the digital select signal line, and configured to receive the digital select signal from the digital select signal line;
a first electrode of the first transistor is coupled to the first digital data signal line, and configured to receive the first digital data signal from the first digital data signal line;
a second electrode of the first transistor is coupled to the latch;
a first electrode of the second transistor is coupled to the second digital data signal line, and configured to receive the second digital data signal from the second digital data signal line; and
a second electrode of the second transistor is coupled to the latch;
wherein the display method further comprises:
turning on the first transistor by a gate-on voltage provided by the digital select signal line, allowing the first digital data signal from the first digital data signal line to pass to a first latch node;
turning on the second transistor by the gate-on voltage provided by the digital select signal line, allowing the second digital data signal from the second digital data signal line to pass to the second latch node; and
latching the first digital data signal and the second digital data signal by the latch.

17. The display method of claim 13, further comprising:
setting a voltage level at the first latch node to be an effective voltage level; and
allowing, by a third subcircuit in the first circuit, the driving current from a second subcircuit in the first circuit to pass through the third subcircuit to the light emitting element.

18. The display method of claim 13, further comprising:
setting a voltage level at the first latch node to be an ineffective voltage level; and
disallowing, by a third subcircuit in the first circuit, the driving current from a second subcircuit in the first circuit to pass through the third subcircuit to the light emitting element.

19. The display method of claim 12, further comprising, in a first phase, providing a turning-on voltage signal through a gate line to a gate electrode of at least a data write transistor, turning on the data write transistor, allowing a data signal provided by the data line pass through the data write transistor, writing the data signal to a first node.

20. The display method of claim 12, wherein the first subcircuit includes a first data write transistor and a second data write transistor;
wherein the display method further comprises, in a first phase, providing a turning-on voltage signal through a first gate line to a gate electrode of the first data write transistor, turning on the first data write transistor;
providing a turning-on voltage signal through a second gate line to a gate electrode of the second data write transistor, turning on the second data write transistor; and
allowing a data signal provided by the data line pass through the first data write transistor and the second data write transistor, respectively, writing the data signal to a first node.
